(19) United States
(12) Patent Application Publication
(10) Pub. No.: US 2008/0215708 A1
(43) Pub. Date: Sep. 4, 2008

(54) Dissecting Sample Sharing System

(75) Inventor: Richard Yeung, Xaimen (CN)

Correspondence Address: DAVIS WRIGHT TREMAINE, LLP/Seattle, 1201 Third Avenue, Suite 2200, SEATTLE, WA, 98101-3045, US

(73) Assignee: Motic China Group Co., Ltd., Xaimen (CN)

(21) Appl. No.: 11/574,133

(22) PCT Filed: Jun. 9, 2005
(86) PCT No.: PCT/CN05/00819

§ 371 Date: Nov. 7, 2007

(30) Foreign Application Priority Data
Aug. 27, 2004 (CN) 200420092141.2

(51) Int. Cl. G06F 15/173

(52) U.S. Cl. 709/219

(57) ABSTRACT

The present invention relates to a dissecting sample sharing system that is composed of a room terminal system and a central control system. The room terminal system at least includes a computer, an image partitioning device and one or more dissecting table units which have image collecting function. The computer sends designation signals to a control case in each dissecting table unit. The control case controls the dissecting table according to the designation signals, and synchronously sends the visual signals, which are obtained from the image collecting device in the dissecting table unit to the image partitioning device. The image partitioning device sends the visual signals to the room terminal system. The central control system is composed of a central control computer and central control software that are connected through network to have communion with each other. The present invention realizes the sample information supply to remote people, it also have interaction system for operators thereby achieves the progress of teaching and research.

### TECHNICAL FIELD

This utility model relates to computer and camcorder field, especially the system of computer connecting and controlling several microscope camcorders.

### BACKGROUND

Generally, when the dissecting sample is performed during classroom, a student performs the sample dissecting at a dissecting table. Due to the relative small partial of the details of dissecting sample, only the main operator knows the details of the sample dissected on the table, while teacher could not be aware of students when they perform the operation on each dissecting table thoroughly, neither could other students. Moreover, the source of samples for teaching is limited; the typical dissecting example shall be demonstrated to all students. However, teacher could neither carry out teaching of dissecting details through video and audio nor communicate with students and guide them. Therefore, such dissecting teaching and learning class is not adequately helpful or effective because not every student can perform the dissecting on his or her own. Even if the students watch the operation surrounding the dissecting table, the problem of blurriness remains.

On the other hand, in the field of medical pathology dissecting teaching and practical field, the dissected tissue samples generally have to be taken away to study by pathology experts, and doctors or teachers work out the treatment plan according to the diagnosis from the experts. At present, this taking sample method cannot meet the demand of quick observation and diagnosis for experts and it limits the experts to service only one hospital. It prevents pathology experts from service widely towards other people fast and also prevents enhancing the efficiency and sharing the precious resources.

Currently, at home and abroad, the problem described above has not been solved in dissecting field.

### INVENTION DESCRIPTION

The utility model provides a dissecting sample sharing system, which enables concerning people to simultaneously observe, store and process the image information collected by zoom camcorder and portable camcorder with one computer in laboratory or classroom and this image information may also be transferred to another computer outside laboratory or classroom, which is controlled by pathology expert. The expert analyzes and processes the image information and sends his diagnosis suggestion back to laboratory or classroom through computer. In such way, the two-way communication between teacher and pathology expert through video and audio in teaching is accomplished.

In order to achieve the purpose described above, the new utility model is composed of a room terminal system (laboratory or classroom) and a central control system. The connection of these two parts is built through the network transmission between the room terminal computer of the room terminal system and the central control computer of the central control system. The room terminal system consists of a room terminal computer with software installed, an image partitioning device and one or more dissecting table units. Each control case unit corresponds to one dissecting table unit. The control case is connected to computer and sends control signal. The room terminal computer controls various parts of dissecting table unit through its control over control case. It may connect with several image partitioning devices and control several control case units. The control case connects with image partitioning device and sends the visual signals. The dissecting table unit is composed of fixed support, camcorder, control case, control keyboard, image display monitor, all movable cradle head, etc.

The central control system is composed of a central control computer and central control software. The central control computer analyzes image information collected from room terminal computer with the functions of central control software, such as user management, video recording, catching moving and still images, white balance, etc. and sends the analysis comments to the room terminal computer which sends image information or to other room terminal computers connecting with it.

The dissecting table unit mentioned above may be one unit or more units. The room terminal computer mentioned above may be one or more connecting with central control computer.

The camcorder head mentioned above has two kinds, one is zoom camcorder and other is portable camcorder head. Zoom camcorder head is fixed at a designated position above the dissecting table, while portable camcorder head is not fixed at a designated position but held in hand. Portable camcorder head is connected with control case and it receives designation from it and acts accordingly. The control case controls image collecting, power supply or the switch between zoom camcorder head and portable camcorder head. Zoom camcorder head could be composed of 1:22 continuous zoom optical lens zooming continuously and turn 359°. The control keys and software control the zooming and angle of camcorder head. Control keyboard may be operated in hand control mode or foot control mode or both. The monitor is fixed above and by the side of the dissecting table, which can show the image shot by the camcorder.

The computer mentioned above may be only one, in which room terminal software is installed for image processing and analysis and audio system control. Thus the computer has the functions of image collection and analysis, output and communication.

The control case mentioned above connects with the computer through image processing software or communication cable, which transmits control signals. The control case connects with the image partitioning device through image processing software or video cord which transmits image collection signals. Control case is equipped with audio controller. With the single-chip microcomputer technology, the control case controls the control keyboard, all movable cradle head, zoom camcorder head, portable camcorder head, video amplifier distributor, etc and various movements of all movable cradle head and zoom camcorder head and audio controller. The control keyboard is a connection controller which controls the movements of cradle head and zooming, focus adjustment, background light adjustment of the camcorder, call and so on. When the key operation on the scanning keyboard is switched to all movable cradle head, above which a camcorder is fixed, and the control case sends designation signals for cradle head movement, then zoom camcorder can catch images. The control keyboard may be operated in the hand control mode or foot control mode or both.

The movable cradle head mentioned above may lead the camcorder head on it to turn left and right, up and down. Zoom camcorder head may catch image with its continuous zoom shooting device.

The image partitioning device mentioned above may be multi-image partitioning device. It is controlled by computer and corresponds to individual dissecting table unit. The number of dissecting table units input computer determines the number of images of image partitioning device sent to computer.

The utility model is equipped with audio control box, its one end is connected to the sound card of terminal computer inside the room and the other end is connected to the audio controller in the control case of each dissecting table unit, literal communication may be achieved among people in the central control room, laboratory or classroom. All the audio controllers are equipped with microphones or speakers with volume control buttons. Microphone and wireless interphone may be connected to the sound card of computer to realize the speech with the people in the laboratory. The utility model is also equipped with video amplifier distributor, which can amplify single-channel video signal and distribute it into multi-channel video signals. In addition, the utility model is attached with projector and LCD.

The central control computer mentioned above may be connected with room terminal computer through network. The central control computer may run the user software of the room terminal computer through the function of starting laboratory or classroom software of its software and then the room terminal computer may connect to the central control computer automatically. Or the user software of the room terminal computer may be started manually and the room terminal computer may be connected to central control computer by clicking the connection button manually.

The central control computer may control room terminal computer and obtain information through its screen control function system. Or the room terminal computer may send the information to be analyzed to central control computer. The central control computer may process and edit information, amplify image or perform other related processing with the functions of its software, such as user management, video recording, catching moving and still images, white balance, etc.

The main functions of the central control software are user management, video recording, catching moving and still images, auto interval catching, setting, console, linkage, basic system, white balance, silencing, background balance and filter lens.

Several units may setup for the user management function and several classes may set for each unit and the stored path of the recorded pictures in each class may be designated.

The function of catching moving and still images is for catching the moving and still images in the current window.

The console mentioned above may automatically control any digital camcorder head to turn on or off, and adjust its brightness, continuous zooming, continuous focus, angle and call for clearance function; adjust picture's brightness.

Linkage function includes one-way linkage, two-way linkage, and non-linkage etc. One-way linkage is to use mouse to select one student channel on the control panel and simultaneously select the corresponding channel on the console, while the channel on the console with the mouse may switch but could not simultaneously switch the corresponding student channel on the control panel. Two-way linkage is to use mouse to select one student channel on the control panel and simultaneously select the corresponding channel on the console, while the student may switch the channel on the console with the mouse and simultaneously switch the corresponding student channel on the control panel. Non-linkage is that the switch of student channel on the control panel with the mouse has no influence on the switch of channel on the console and vice versa.

The main functions of advanced system are color control, white balance, noise-control, background balance, filter lens. The red value, green value and blue value of the images can be adjusted within the range of ±100.

The central control software has the functions of communication, file transmission, window management, member setting, speech communication, image transmission and so on.

Text communication function is for the text communication between dissecting terminal and central control terminal.

File transmission function is for sending files to dissecting terminal.

Speech communication is consisted of broadcast data mode, group mode and dialogue mode.

The broadcast data mode only allows the pathology expert at central control terminal to speak to the people at each room terminal computer landing on the system; the group mode allows pathology expert at central control terminal to join one group of dissecting terminals and to communicate with the dissecting terminals within the group. The dissecting terminals within the group may have dialogue with the doctor at the central control terminal. The pathology expert at the central control terminal may select one group and then click JOIN DISCUSSION GROUP or QUIT DISCUSSION GROUP buttons to join or left the current groups. The dialogue mode allows the pathology expert at the central control terminal to select one dissecting terminal to have dialogue individually. If you want to be heard by other dissecting terminals, please select PUBLIC TALK option.

Image transmission function is performed in such way that central control terminal screen sends its images to all dissecting room terminals. At this moment, the central control terminal may process images while dissecting terminal may not.

DISSECTING ROOM IMAGE option may transmit the image caught by one dissecting terminal camcorder to all the other dissecting terminals. After selecting this option, select one department from the dissecting channel pulldown menu and it may transmit the image to that department, and this function is also called as image download. Those mentioned above are the main functions of the major software of this utility model. No discussion about other software is preceded at this moment.

User may press button or use the software to change the focus of camcorder, zooming in and out, move the camcorder to acquire the expected image effect according to your requirement and transmit the visual signal to image partitioning device and then to computer. All in all, combining with the software, this utility model is advanced and practical.

The main advantages of the utility model:
1. The utility model makes the details of the dissecting process clearer. The camcorder and projector amplifies the images and all the people in the laboratory or classroom can see the dissecting details clearly and get to know the process of operation accurately, as if they were the main operator.
2. The utility model facilitates resource sharing during the dissecting process and enables pathology expert to offer rapid solution. Due to the simultaneous connection of central control computer and the room terminal computers of several laboratories or classrooms, the central control computer may obtain image information from one room terminal computer of a laboratory or classroom and send the analysis comments back to the laboratory or classroom and at the same time send to other laboratories or classrooms to share the resources after pathology expert analyzes and processes it. Moreover, the pathology expert may illustrate the difficulties and answer the students' questions on site combing with the dissecting images with the help of the audio control box connecting with sound cards of room terminal computer and central control computer. In this way, it may greatly save precious samples and reduce the cost of teaching and learning and solve the related problems in time.
3. The portable camcorder of the utility model can catch the images of the internals of the sample or inside and outside and lower surface of the dissected sample where zoom camcorder cannot. It can shoot some unobtainable “dead corner” of the sample.
4. The image partitioning device of the utility model enables the room terminal computer to have 16 image, 9 image and 4 image display. And the user may simultaneously monitor the dissecting processes at several dissecting tables and correct and handle problems timely. It may process the visual signals from the camcorders above the dissecting tables and send them to computer. User may select typical dissecting case and storing, recording, illustrating it timely.
5. The central control computer of the utility model can process and edit the information obtained through the functions of the room terminal software such as, user management, video recording, catching moving and still images, white balance and so on. It enhances the processing efficiency of computer and makes the images clearer and more accurate and the utility model more advanced.

The utility model is a video and audio system integrating electronics and software. This sharing system is especially applicable for the dissecting sample with the feature of high automation.

### ATTACHED FIGURES

FIG. 1 System Construction of Utility Model

FIG. 2 Construction of the Room Terminal System

FIG. 3 Functions of Room Terminal System

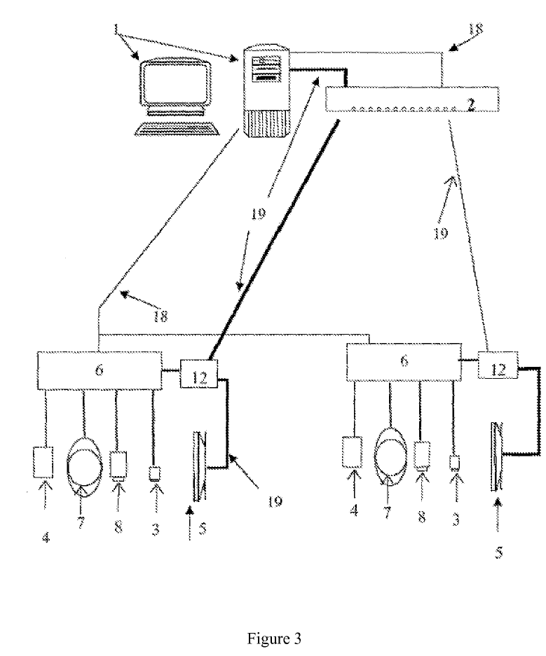

FIG. 4 Principles of Utility Model

### SPECIFICATIONS

The following figures and examples provide further explanation for this utility model.

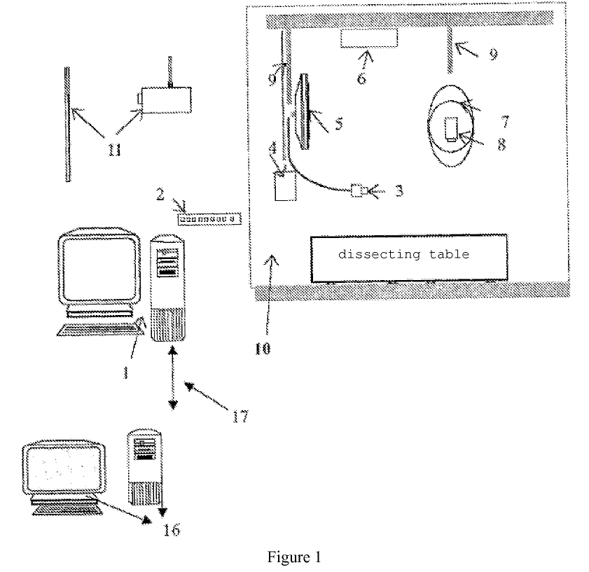

As indicated in FIG. 1, this utility model is composed of a room terminal system and a central control system.

Room terminal system includes a room terminal computer 1, an image partitioning device 2 (16 image), a control keyboard 4, a monitor 5, a control case 6, an all-movable cradle head 7, an internal zoom camcorder 8, a fixed support 9, and a projecting system 11, etc. Meanwhile, the central control system is composed of a central control computer and central control software. The room terminal system and the central control system are connected through network 17, which enable communication between room terminal computer 1 and central control computer 16 with each other.

The dissecting table unit consists of a fixed support 9, a control case 6, a control keyboard 4, a monitor 5, an all-movable cradle head 7 and a zoom camcorder 8, which is fixed, in it. The control keyboard 4 is connected to the control case. One is able to control the movements of all-movable cradle head 7 and other functions such as zooming of the camcorder by pushing different buttons on the control keyboard 4.

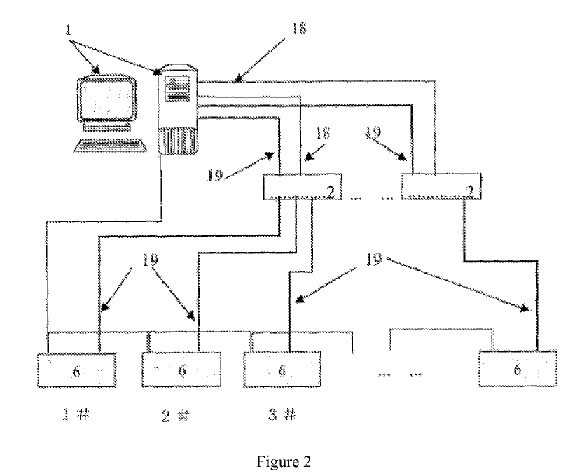

As illustrated in FIG. 2, the room terminal computer 1 and the image partitioning device 2 are connected through communication control cable 18 with each other; the image partitioning device 2 is connected with the control case through cable 485, which has a function of transmitting software with no limit; computer sends designation signals through cable 18 and 485 to each control case 6; the control case and the image partitioning device are connected through visual signal cable 19 which sends the visual signals. As showed in 3, any dissecting table unit 10 can inform the room terminal computer by using audio system 15, if there is any question. The room terminal computer sends the designation signals of collecting image to the control case. The control case will collect relevant image through the zoom camcorder by controlling the keyboard 4. The collected images will be distributed by video amplifier 8 distributor chosen by the control case and then sent into two channels; one will be sent to the monitor 5 in order to show the image of the sample, the other one will be sent to the image partitioning device 2 for image partitioning before shown in computer 1. Both the all-movable cradle head 7 and its internal zoom camcorder 8 are connected to control case 6. The SCM inside the control case controls the movements of all-movable cradle head 7 and other functions such as zooming of the camcorder; the portable camcorder 3 is connected to the control case as well, so that the control case can switch between portable camcorder and the zoom camcorder according to one's needs.

By using the portable camcorder, one is able to observe the conditions of dissecting sample from various angles or even dead angle. The portable camcorder can be used to collect images from different perspectives. Besides, other procedures are similar to the procedures for operating the zoom camcorder. And finally, the video output will show the collected images.

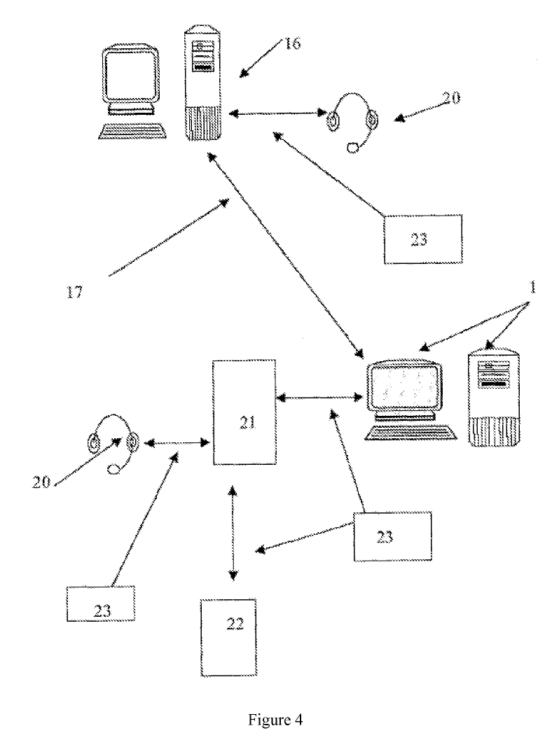

As indicated in FIG. 4, after the software-controlled audio system is installed, this system can realize the communication between the room terminal computer and staff at the dissecting table through audio controller inside the control case 6. Or one can install the audio system by connecting wireless interphone 20 or microphone power amplifier system 22 to computer 1. Then communication with the room terminal computer 1 can happen by pressing the audio controlling buttons on the control case. The wireless interphone 20 of the room terminal system is connected to the central computer 16 through the audio cord 23. And the wireless interphone 20 or the microphone power amplifier system 22 of the central control system is connected to the earphone, the sound box switcher 21 through the audio cord 23. The earphone and the sound box switcher 21 are connected to the central control computer. Thanks to the switch function of the earphone and the sound box switcher, one can use either the wireless interphone or the microphone power amplifier system.

As indicated in FIG. 1, 2, 3, 4, this utility model of the room terminal system is controlled by a room terminal computer, and can be connected to one or more dissecting table units 10 in FIG. 1. Computer 1 and the image partitioning device 2 are connected through the communication control cable 18. The room terminal computer 1 sends the designation signals to the control case 6; the control case receives and decodes the signals in its MCU; after decoding, MCU sends the control signals to both the all-movable cradle head 7 and the internal zoom camcorder 8, so that they can collect images according to the signals; then the collected images can be analyzed and processed by the room terminal computer. In this way, the image data collected from one of the dissecting table units can be sent to other units, therefore the sharing of information is realized.

Once the room terminal computer and the central control computer are connected through LAN or Internet with each other, they will be able to communicate with each other by the means of software collecting, information analyzing and processing. The central control computer can obtain information from the room terminal computer. Similarly, the room terminal computer can send the information to be analyzed to the central control computer. After processing, the central computer will send the image information back to the room terminal computer for the purposes of staff and students' learning and reference.

The major functions of the central control software are as follows: user management, video recording, catching still image, auto interval catching, setting, console, linkage, basic system, and advanced system, etc. Through the functions mentioned above, the screen of the room terminal computer 1 can be real-time displayed on the specific display area in the central control computer. The function of screen control enables the central control software to control the room terminal computer 1 and carry out any operation on the room terminal computer 1. When several laboratories or classrooms are available, the central control computer 16 can adopt its image download function to make its screen visible in every laboratory or classroom, and the images can be collected by the terminal computers in all the rooms.

Free communication between the central control system and the laboratory or classroom terminal can be achieved by using either software's audio communicating and text functions or microphone.

If a question found out in any of dissecting table units and its needs to do further discussion, the person in a laboratory or classroom can call the central control system by using the audio calling function above. After the central control computer 16 responses, it can control the room terminal computer 1 through the screen control function. It can then amplify the image of the calling unit or take other relevant measures. The image data can also be enlarged by using the projecting system 11, if the administrator in the room terminal thinks it is necessary. Afterward, combining with the wireless interphone or the microphone power amplifier system, the pathologist can explain to or have a discussion with teachers in the room terminal. Meanwhile, through the image downloading function and the screen sharing function, one can make the whole process available for any other classrooms.

1.-15. (canceled)

16. A dissecting sample sharing system comprising:
a central control system;
a room terminal computer coupled to the central control system configured to generate a designation signal; and
a plurality of image collection systems each communicatively coupled to the room terminal computer and configured to receive the designation signal generated thereby, each of the image collection systems being configured to collect images of a dissection sample in response to receiving the designation signal and transmit the images collected to the room terminal computer, the room terminal computer being configured to receive the images transmitted by the image collection systems and transmit the received images to the central control system.

17. The system of claim 16, wherein each of the image collection systems comprise a portable camcorder or zoom camcorder.

18. The system of claim 16 for use with a plurality of users, wherein the room terminal computer is configured to transmit the designation signal to a selected image collection system without transmitting the designation signal to all image collection systems, the system further comprising:
a plurality of dissection table units configured for use by the users, each of the dissection table units comprising one of the image collection systems and a display system coupled to the room terminal computer, the display system being configured to display the images collected by the selected image collection system in response to the designation signal transmitted thereto.

19. The system of claim 18, wherein the display system comprises a projection system configured to display the images collected by the selected image collection system to the users of fewer than all the dissection table units.

20. The system of claim 18, wherein the display system comprises a monitor configured to display the images collected by the selected image collection system to the user of at least one of the dissection table units.

21. The system of claim 1, wherein the central control system is configured to control the room terminal computer and command the room terminal computer to generate the designation signal and transmit images collected in response thereto to the central control system.

22. The system of claim 1, wherein the room terminal computer is configured to transmit the designation signal to a selected image collection system without transmitting the designation signal to all image collection systems and the central control system is configured to control the room terminal computer and command the room terminal computer to transmit the designation signal to the selected image collection system and transmit images collected in response thereto to the central control system.

23. The system of claim 1, wherein each of the image collection systems comprises a camcorder having a zoom level and a control, the control being configured to determine the zoom level of the camcorder.

24. The system of claim 1 for use by a plurality of users, wherein each of the image collection systems comprises a camcorder and a control, the system further comprising a monitor, the control being configured to receive the images collected by the camcorder and display the images on the monitor to one of the users.

25. The system of claim 1, wherein each of the image collection systems comprises a camcorder mounted to a movable cradle and a control, the designation signal generated by the room terminal computer including as a portion thereof a movable cradle positioning signal, the control being configured to receive the designation signal and position of the movable cradle in response to the movable cradle positioning signal portion of the received designation signal.

26. The system of claim 1 for use by a plurality of users, further comprising a plurality of dissection table units each configured to be used by one of the users and comprising one of the image collection systems and an audio system coupled to the room terminal computer and each of the dissection table units, the audio system being configured to transmit audio data between the room terminal computer and the users of the dissection table units.

27. The system of claim 26, wherein the audio system comprises wireless interphone or wireless microphone.

28. The system of claim 1, further comprising a plurality of dissection table units each comprising one of the image collection systems and an image partitioning device configured to partition images collected by the image collection system before the images are transmitted to the room terminal computer.

29. The system of claim 1, wherein the image collection systems comprise a zoom camcorder having a 1:22 continuous zoom optical lens that can rotate at least 359°.

30. The system of claim 1 for use by a plurality of users, wherein each of the image collection systems comprises a control configured to respond to commands entered into an input device, the system further comprising:
a plurality of dissection table units each configured for use by one of the users, each dissection table unit comprising one of the image collection systems, the input device being configured to receive input from the user and transmit the input to the control.

31. The system of claim 30, wherein each of the input devices comprises a hand control or foot control.

32. The system of claim 1, wherein the central control system is configured to transmit information to the room terminal computer.

33. The system of claim 1 for use by a plurality of users, wherein the central control system is configured to transmit information to the room terminal computer, and the system further comprises:
a plurality of dissection table units, each configured for use by one of the users, each dissecting table unit comprising one of the image collection systems and a display, the room terminal computer being configured to transmit information received from the central control system to the display of at least one of the dissection table units.

34. The system of claim 1, further comprising image analysis components configured to analyze the images collected.

35. The system of claim 1, further comprising image processing components configured to process the images collected.

36. The system of claim 1, wherein the image collection systems are coupled to the room terminal computer by a plurality of image partitioning devices and the image partitioning devices are configured to provide the room terminal computer with partitioned images that include images collected from a portion of the image collection systems simultaneously.

37. The system of claim 1 for use by a plurality of users, wherein each of the image collection systems comprises a control that is coupled to an image partitioning device and the image partitioning device is configured to provide the control with partitioned images that include images collected from the portion of the image collection systems simultaneously, the system further comprising:
a display system coupled to each of the controls of the image collection systems and configured to display the partitioned images provided to the control by the image partitioning device to one of the users.

38. The system of claim 37, wherein the control comprises an SCM control.

39. The system of claim 37, wherein the image partitioning device is configured to receive the designation signal generated by the room terminal computer, and the images collected from the portion of the image collection systems included in the partitioned images are determined by the designation signal.

40. The system of claim 1, further comprising a plurality of second room terminal computers substantially similar to the room terminal computer, each of the second room terminal computers being coupled to a unique plurality of image collection systems and the central control system, the central control system being configured to transmit information to each of the second room terminal computers.

41. The system of claim 1, wherein the central control system is configured to receive and record the collected images.

42. The system of claim 1, wherein the central control system is configured to receive and to process the collected images and transmit the processed images to the room terminal computer.

43. An information transfer method for transferring information related to a dissection sample from an expert to a plurality of users, the method comprising:
collecting images of a dissection sample as the dissection sample is being dissected;
allowing the expert to determine which images are collected during the dissection; and
transmitting information related to the dissection or dissection sample from the expert to the plurality of users.

44. The method of claim 43, wherein the dissection of the sample is performed by one or more of the users.

45. The method of claim 44, wherein each of the users is performing a dissection of a dissection sample substantially similar to the dissection sample of which images are collected.

46. The method of claims 43, further comprising transmitting a question related to the dissection or dissection sample from one of the users to the expert and transmitting a response from the expert to the user from which the question originated.

47. The method of claim 43, further comprising displaying the images collected to the plurality of users.

48. The method of claim 43, wherein the dissection of the sample is performed by the expert.

49. A dissecting sample sharing system comprising:
a central control system having a central control computer and central control software; and
a room terminal system including:
at least a computer,
a plurality of imaging partitioning devices, and
one or more dissecting table units for the purposes of image collection, the one or more dissecting table units having respective control cases, wherein the computer of the room terminal system is connected to the plurality of image partitioning devices which are also connected to respective control cases of the one or more dissecting table units, the room terminal computer is operable to control one or more of the dissecting table units through the control case connections, and the central control system and room terminal system are operable to be connected through a network between the computers of each system and communicate with each other by means of a software collection.
